(19) United States
(12) Patent Application Publication
(10) Pub. No.: US 2010/0162983 A1
(43) Pub. Date: Jul. 1, 2010

(54) PNEUMATIC STARTING SYSTEM

(76) Inventor: Bruce McGrew, Colorado Springs, CO (US)

Correspondence Address: WELSH & FLAXMAN LLC, 2000 DUKE STREET, SUITE 100, ALEXANDRIA, VA, 22314, US

(21) Appl. No.: 12/649,859

(22) Filed: Dec. 30, 2009

Related U.S. Application Data
(60) Provisional application No. 61/193,844, filed on Dec. 30, 2008.

(51) Int. Cl. F02N 7/00

(52) U.S. Cl. 123/179.31

(57) ABSTRACT

A pneumatic starter system for a combustion engine of a recreational vehicle including one or more pistons moving within a respective plurality of cylinders includes a pneumatic pressure source and a starter converting the pneumatic pressure source into rotational force applied to the one or more pistons causing movement of the one or more pistons and ignition of the combustion engine.

### CROSS REFERENCE TO RELATED APPLICATION

This application claims the benefit of U.S. Provisional Patent Application Ser. No. 61/193,844, entitled “PNEUMATIC STARTING SYSTEM”, filed Dec. 30, 2008.

### BACKGROUND OF THE INVENTION

1. Field of the Invention

The invention relates to a pneumatic starting system for a motor. More particularly, the invention relates to a pneumatic starting system for a four-stroke combustion engine of a recreational vehicle (for example, motorcycles (both recreational and competitive), ATVs (all terrain vehicles), watercraft and other relatively small powered machines).

2. Description of the Related Art

Millions of people enjoy outdoor recreation while using motorcycles, ATVs, watercraft and other powered machines. These machines provide opportunities for exploring, riding and even racing. The performance of the engines in these machines is essential to the enjoyment of those using the vehicles.

Until recently, many off road motorcycles, ATVs and other machines utilized two-stroke engines. Two-stroke engines offer the advantage of compact size, power and inexpensive manufacturing. Because of this, they were frequently used for recreation equipment. However, two-stroke engines have some inherent drawbacks. In particular, they are inefficient as they burn oil and gas together resulting in the creation of a lot of pollution. Further, two-stroke engines are not as long lasting and reliable as other options.

With this in mind, most recreational vehicle equipment and machine companies have begun replacing two-stroke engines with four-stroke engines. Similar to what is under the hood of most automobiles, four-stroke engines can provide advantages in efficiency, cleanliness and durability.

One problem with four-stroke engines when used in conjunction with recreational vehicles occurs when it is necessary to restart a four-stroke engine. When encountering difficult environmental conditions, four-stroke engines are prone to stall. For example, when a trail bike rider is riding in difficult terrain, the four-stroke motor may stall on occasion when encountering large obstacles or when the trail bike falls over. When staffing such as this occurs with a two-stroke engine, it is relatively easy to restart the two-stroke engine by simply kick-starting the bike and continuing the ride. Due to its design and operating parameters, a four-stroke engine is inherently more difficult to restart particularly when hot.

Manufacturers have attempted to utilize electronic start systems in conjunction with these four-stroke engines. However, electronic start systems require large and relatively heavy batteries. While heavy batteries may be acceptable with street bikes and golf carts, this solution is less desirable with recreational machines such as trail or dirt bikes. The added complexity and weight is unacceptable to many riders, especially those who race. Even the best electronic start systems weigh about ten pounds. Ten pounds can constitute a significant percentage of the entire weight of a trail or dirt bike; perhaps five percent of the entire weight of the bike. In addition, electrical start systems are complicated and are, therefore, prone to failure and maintenance issues. Where an electronic start system is unacceptable, manufacturers have employed kick-start mechanisms. However, kick-start mechanisms may require repeated attempts or simply waiting for the engine to cool before restarting. Kick-starting a powerful engine is not an enjoyable or practical activity.

As such, a need exists for a mechanism whereby recreational vehicles employing four stroke engines may be easily restarted. The present invention provides such a start system.

### SUMMARY OF THE INVENTION

It is, therefore, an object of the present invention to provide a pneumatic starter system for a combustion engine of a recreational vehicle including one or more pistons moving within a respective plurality of cylinders. The pneumatic starter system includes a pneumatic pressure source and a starter converting the pneumatic pressure source into rotational force applied to the one or more pistons causing movement of the one or more pistons and ignition of the combustion engine.

It is also an object of the present invention to provide a pneumatic starter system wherein the starter includes a rotor assembly.

It is another object of the present invention to provide a pneumatic starter system wherein the combustion engine is a four-stroke combustion engine.

It is a further object of the present invention to provide a pneumatic starter system wherein the starter is coupled to a drive shaft of the combustion engine to initiate combustion sufficient to fire the combustion engine.

It is also an object of the present invention to provide a pneumatic starter system wherein the starter includes a starter housing in which a rotor assembly is linked to the pneumatic pressure source for rotation of a drive gear.

It is another object of the present invention to provide a pneumatic starter system wherein the drive gear is connected to the drive shaft of the combustion engine for rotation thereof.

It is a further object of the present invention to provide a pneumatic starter system wherein the starter housing includes an intake port for selective connection of the pneumatic pressure source thereto via a connection tube.

It is also an object of the present invention to provide a pneumatic starter system including a cable actuated control valve forming part of the starter which selectively allows air or gas pressure from the pneumatic pressure source to supply energy to the starter.

It is another object of the present invention to provide a pneumatic starter system wherein the cable is connected to an actuator lever.

It is a further object of the present invention to provide a pneumatic starter system wherein the control valve is positioned between the intake port and the rotor assembly.

It is also an object of the present invention to provide a pneumatic starter system wherein the control valve includes a closure seal positioned for movement within a gas lumen formed in the starter housing for connecting the intake port to the rotor assembly.

It is another object of the present invention to provide a pneumatic starter system wherein the closure seal is mounted for movement between a closed position where it seats upon a valve seat surface formed on an inner wall of the gas lumen and an open position where it is moved from the valve seat surface and pressurized gas is allowed to freely pass from the intake port to the rotor assembly.

It is a further object of the present invention to provide a pneumatic starter system wherein the rotor assembly includes an internal housing in which a rotor is positioned for rotation therein.

It is also an object of the present invention to provide a pneumatic starter system wherein the rotor includes a plurality of resiliently biased vanes which are acted upon by pressurized gas or air from the pneumatic pressure source in a manner causing rotation thereof.

It is another object of the present invention to provide a pneumatic starter system wherein the pneumatic pressure source is mounted to an engine block of the recreational vehicle directly adjacent the combustion engine.

It is a further object of the present invention to provide a pneumatic starter system wherein the pneumatic pressure source is formed in a swing arm of the recreational vehicle.

It is also an object of the present invention to provide a pneumatic starter system wherein the pneumatic pressure source is a pressurized air cylinder.

It is another object of the present invention to provide a pneumatic starter system wherein the starter and the pneumatic pressure source are mounted to or in a frame of the recreational vehicle adjacent the combustion engine.

It is a further object of the present invention to provide a pneumatic starter system wherein the pneumatic pressure source is constructed as part of a frame, engine block or swing arm of a conventional dirt bike.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a perspective view of a dirt bike including the present pneumatic starter system.

FIG. 2 is a detailed view of the dirt bike handle showing a lever for actuation of the present pneumatic starter system.

FIG. 3 is a schematic of a cylinder used in a four-stroke engine.

FIG. 4 is a detailed view showing the starter secured adjacent the motor of the dirt bike.

FIG. 5 is a perspective view of the starter in accordance with the present invention.

FIG. 6 is a top plan view of the starter shown in FIG. 5.

FIG. 7 is a cross sectional view of the starter shown in FIG. 6 along the line 7-7.

FIG. 8 is a cross sectional view of the starter shown in FIG. 6 along the line 8-8.

FIG. 9 is a cross sectional view showing the details of the control valve controlling the flow of pressurized air to the starter.

FIG. 10 is an exploded view of the starter shown in FIG. 6.

FIG. 11 is a side plan view of the starter shown in FIG. 6.

FIG. 12 is a cross sectional view of the starter shown in FIG. 11 along the line 12-12.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

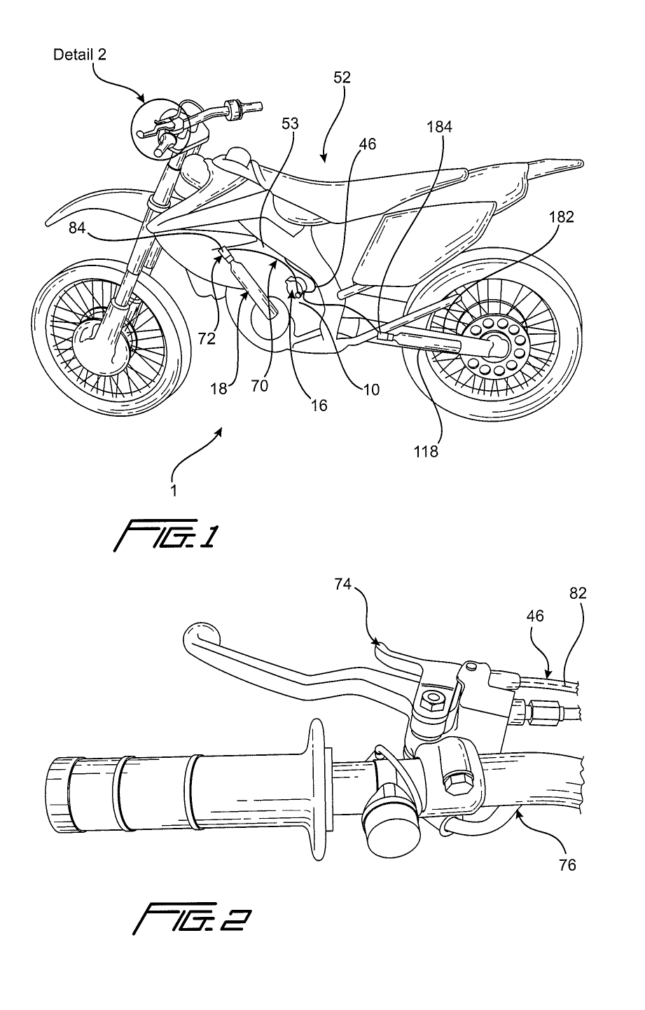

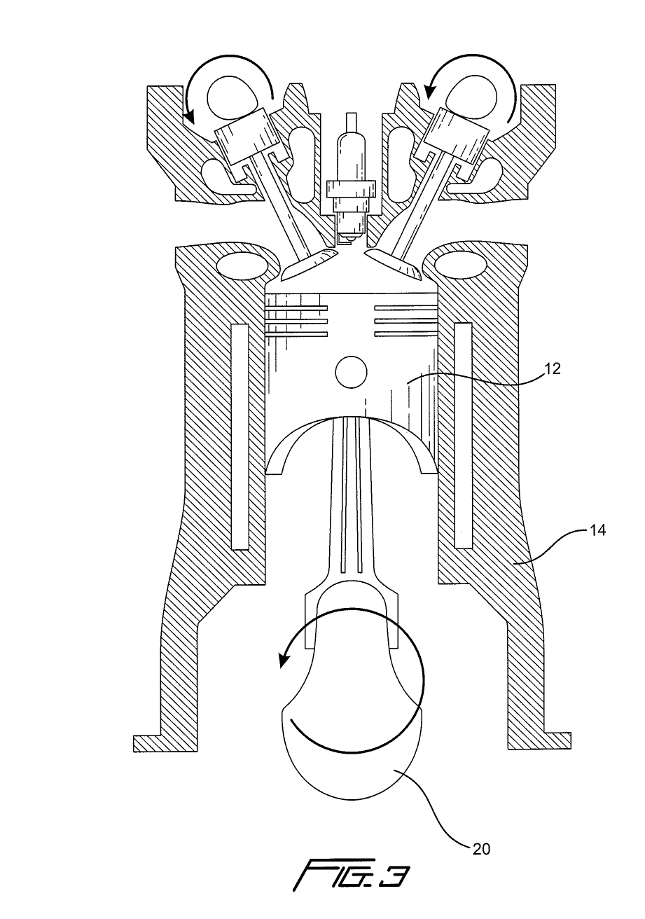

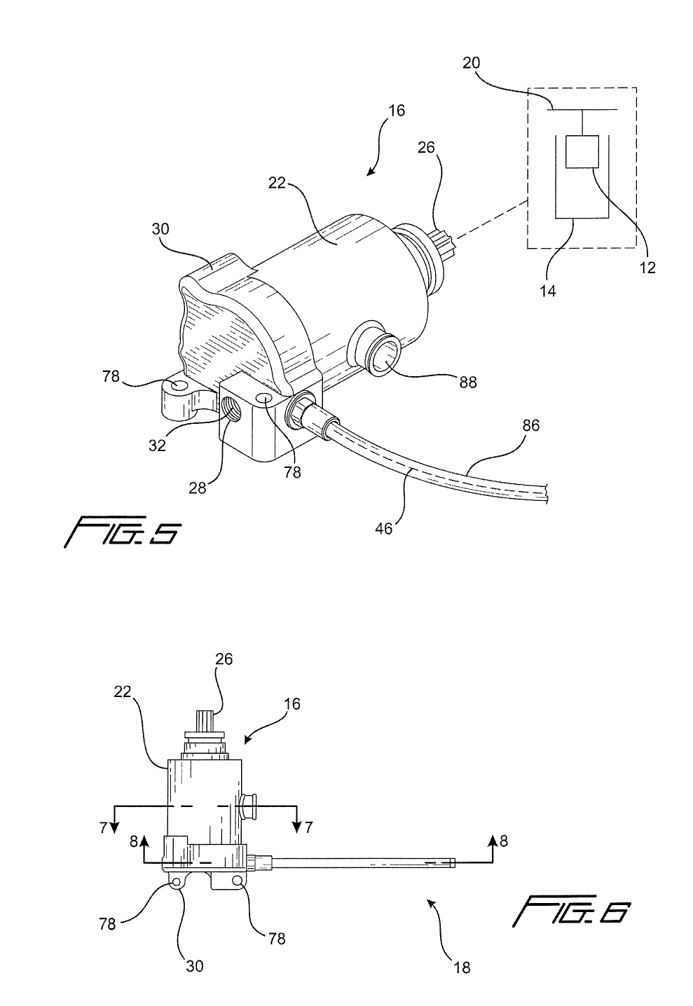

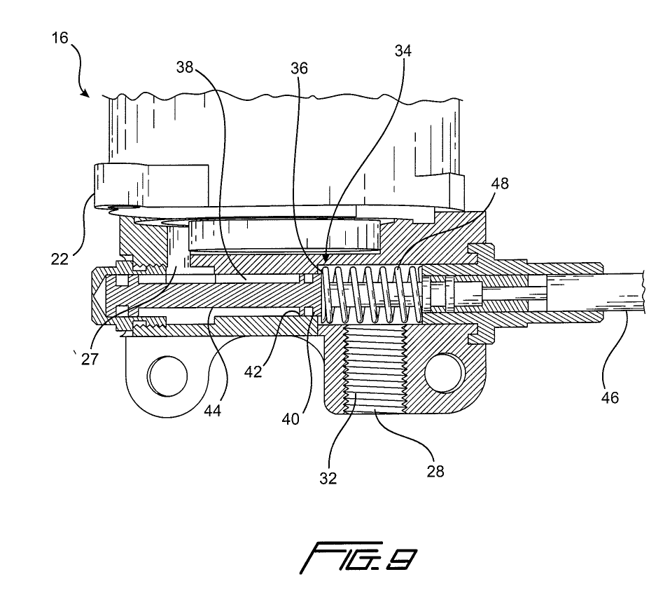

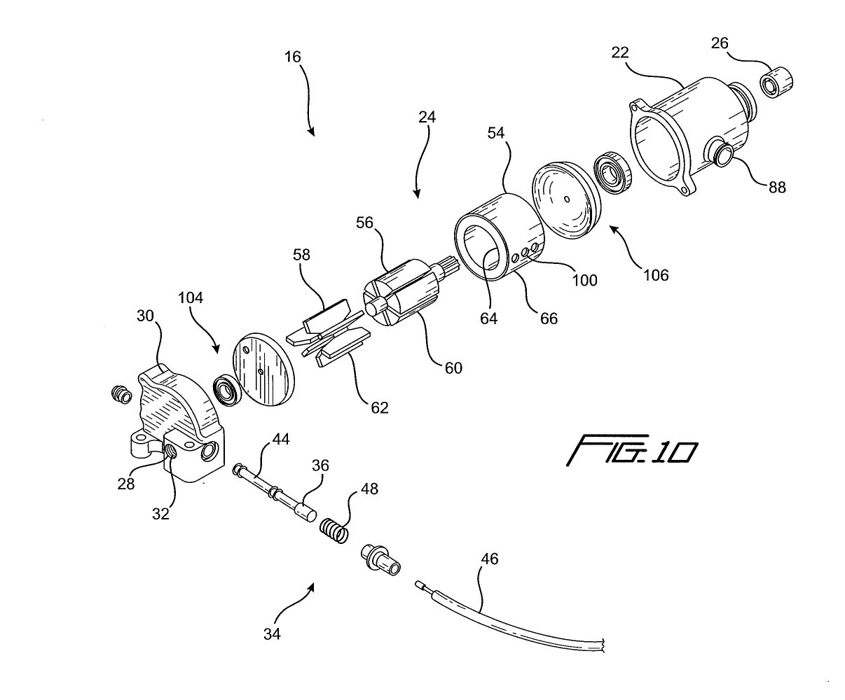

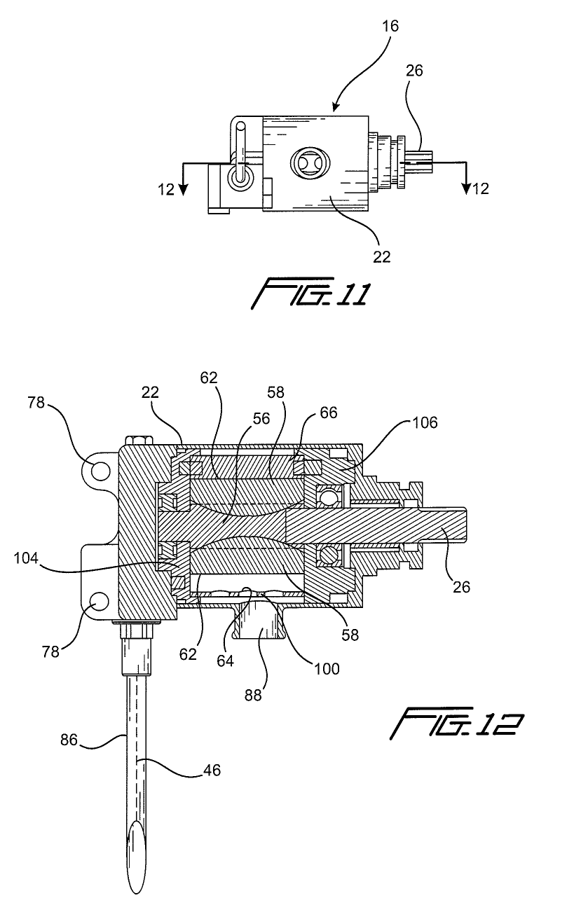

In accordance with the present invention, and with reference to FIGS. 1 to 12, a pneumatic starter system 1 for a combustion engine 10 is disclosed. The combustion engine 10 includes one or more pistons 12 moving within a respective plurality of cylinders 14. A starter 16 is associated with the combustion engine 10 and includes a pneumatic pressure source 18 (for example, a pressurized air cylinder). As will be appreciated based upon the following disclosure, the starter 16 and pneumatic pressure source 18 are mounted to or in the frame 53 of a vehicle 52 adjacent the combustion engine 10. In accordance with a preferred embodiment of the present invention, and as discussed below in greater detail the pressure source 18 may be constructed as part of the frame, engine block or swing arm of a conventional dirt bike 52. The starter 16 converts the pneumatic pressure source 18 into rotational force effectively replacing the electric starter motors in a conventional electronic starting system. The rotational force generated by the pneumatic pressure source 18 is applied to the one or more pistons 12 causing movement of the one or more pistons 12 and ultimately ignition of the combustion engine 10 which rotation/ignition is then perpetuated during operation of the engine in a conventional manner known to those skilled in the art. As those skilled in the art will certainly appreciate, the combustion engines used in conjunction with recreational motor sport equipment are commonly single cylinder engines with displacements of 200 cc to 600 cc.

The present pneumatic starter system 1 is preferably for dirt bikes 52 competing in Motocross and Supercross, although those skilled in the art will certainly appreciate other applications for the present pneumatic starter system 1. The present pneumatic starter system 1 is much lighter in weight than electric starters making it highly advantageous for use in competition. The present pneumatic starter system 1 would be desirable when a rider goes down and stalls the combustion engine 10. The present pneumatic starter system 1 would then quickly start the combustion engine 10 so the rider can continue in the race.

As will be appreciated based upon the following disclosure, the present pneumatic starter system 1 uses compressed (or pressurized) air or gas to spin a rotor assembly 24 of a starter 16. The housing 22 of the starter 16 is preferably shaped and dimensioned to resemble a standard electric starter motor and is secured to the dirt bike 52 by bolts 80 in a standard fashion. The starter housing 22 is fitted with a cable actuated control valve 34 which selectively allows the air or gas pressure from the pneumatic pressure source 18 to supply energy to the starter 16. The cable 46 includes a sheath 86 and leads to the handle bar 76 and connects to an actuator lever 74 that the rider can pull with his finger to start the dirt bike 52. Inside of the cable sheath 86 is the actual cable 46 that connects the lever 74 to the actuator control valve 34. After the motorcycle starts and the rider lets go of the lever 74 a spring shuts the pressure supply off to the starter 16. This is accomplished when the closure seal 36 engages the valve seat surface 40 as discussed below in greater detail.

In accordance with a preferred embodiment, the combustion engine 10 is a four-stroke combustion engine employed in conjunction with a recreational vehicle, for example, a dirt bike 52 as shown in FIG. 1. As those skilled in the art will certainly appreciate, the four-strokes of a four-stroke combustion engine 10 refer to the various cycles of the combustion process. In accordance with a four-stroke cycle, the four-strokes are: intake, compression, power and exhaust. More particularly, and with reference to FIG. 3, the intake stroke involves downward movement of the piston 12 within a cylinder 14. This downward movement draws a fresh charge of vaporized fuel/air mixture into the cylinder 14. The vaporized fuel/air mixture may be drawn into the cylinder 14 via an intake valve, for example, by a poppet valve, which is drawn open by the vacuum produced as a result of the intake stroke. Once the intake stroke is completed, the compression stroke begins. The compression stroke begins as the piston 12 rises within the cylinder 14 and the poppet valve is forced shut by the increased cylinder pressure. Once the engine is running, flywheel momentum of the engine 10 drives the piston 12 upward, compressing the vaporized fuel/air mixture.

However, and prior to the ignition of the four-stroke combustion engine 10, extra force is required to complete the movement of the drive shaft (or crank) 20 which ultimately drives the piston 12 up and down within the cylinder 14. As such, a starter 16 is employed as discussed below to begin operation of the four-stroke cycle, which once started, is maintained by the explosions occurring in the cylinder 14 as a result of the combustion taking place therein; hence the need for the present starter 16.

Once the piston 12 reaches the top of the compression stroke, the spark plug fires, igniting the compressed fuel. As the fuel burns within the cylinder 14 where it is confined within a limited space by the cylinder 14 and piston 12, the fuel expands driving the piston 12 downwardly creating the power stroke. Once the piston 12 reaches the bottom of the power stoke, the exhaust valve is opened by a cam-lift or mechanism. The upward stroke of the piston 12 drives the exhausted fuel out of the cylinder 14 and the process begins again with the intake stroke.

As discussed above, initiation of the four-stroke cycle employed in accordance with the four-stroke combustion engine 10, or any other engine utilizing combustion power, requires rotation of the drive shaft 20 to initiate the four-stroke cycle creating the initial piston movement generating combustion sufficient to fire the combustion engine 10. In particular, the piston 12 must be moved before the ignition phase of the four-stroke cycle. This means that the piston 12 must be set in motion by an external force before it can continue to move up and down via internal combustion in each cylinder. The present starter 16 achieves this goal.

While use of the present invention is disclosed herein with reference to four-stroke engines, it is certainly contemplated the present invention may be used with two-stroke engines or other engines requiring assistance in starting that might benefit from the present invention.

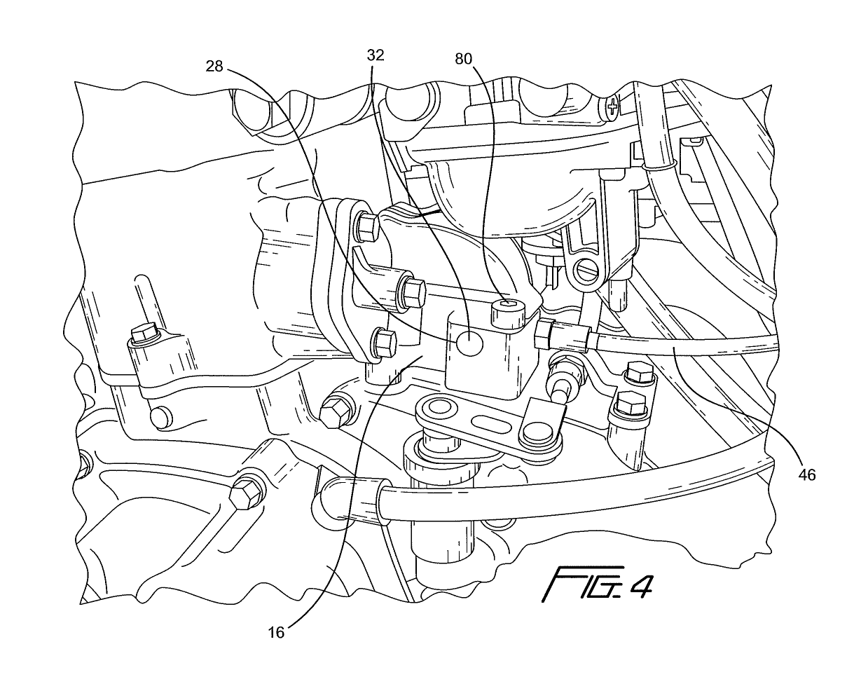

In accordance with a preferred embodiment of the present invention, the starter 16 is linked to the drive shaft 20 of the combustion engine 10 to allow the starter 16 to rotate the drive shaft 20 in a manner causing linear movement of the various piston(s) 12 within the respective cylinder(s) 14 for ignition of the combustion engine 10. Referring to FIGS. 4 to 12, the starter 16 includes a starter housing 22 in which a rotor assembly 24 is linked to the external pressure source 18 for rotation of a drive gear 26. The drive gear 26 is ultimately connected to the drive shaft 20 of the combustion engine 10 for rotation thereof. The starter housing 22 also includes mounting apertures 78 through which bolts 80 pass for securing the starter 16 to the frame or engine block of the dirt bike 52.

In accordance with one embodiment and as shown with reference to FIG. 1, the external pressure source 18 is mounted to the engine block of the dirt bike 52 directly adjacent the combustion engine 10 itself. However, and with reference to FIG. 1, an external pressure source 118 may be incorporated into the swing arm 182 of the dirt bike 52. It is contemplated such a construction would provide protection for the external pressure source 118 while also enhancing the aesthetic appearance of a dirt bike 52 incorporating the present invention. Regardless of the embodiment chosen for implementation of the present invention, a regulator 84, 184 is provided at the outlet of the vessel making up the external pressure source (or high pressure source) 18, 118 to supply the correct amount of air or gas pressure to the starter 16. It is contemplated the vessel would be sized to include enough pressurized gas for 4 to 6 starts.

Referring first to the intake port 28, the intake port 28 is formed along a first end 30 of the starter housing 22 and includes internal threading 32 for selective connection of the pressurized external pressure source 18 thereto. In accordance with a preferred embodiment, the pressurized external pressure source 18 is a pressurized air source having an output 72 that is connected into the intake port 28 via a connection tube 70, for fluid communication with the working components of the present starter 16. Although the pressure source is air in accordance with a preferred embodiment, other gases, for example, nitrogen may be employed within the spirit of the present invention. In addition, it is contemplated CO₂ fluid may be employed. As those skilled in the art may appreciate, liquid CO₂ when held under pressure remains in liquid form until such time that it is released to the atmosphere and then converts to gas.

In order to control the flow of pressurized gas from the intake port 28 to the rotor assembly 24, a control valve 34 is provided and positioned between the intake port 28 and the rotor assembly 24. The control valve 34 includes a closure seal 36 positioned for movement within a gas lumen 38 formed in the starter housing 22 for connecting the intake port 28 to the rotor assembly 24. The closure seal 36 is mounted for movement between a closed position where it seats upon a valve seat surface 40 formed on the inner wall 42 of the gas lumen 38 and an open position where it is moved from the valve seat surface 40 and pressurized gas is allowed to freely pass from the input port 28 to the rotor assembly 24 via the gas lumen 38 and the intake port 27 for the cavity 25 of the rotor assembly 24.

The closure seal 36 is mounted upon a support rod 44 for longitudinal movement between its closed position and its open position. More particularly, the support rod 44 extends along the longitudinal axis of the gas lumen 38 moving the closure seal 36 from a position in contact with the valve seat surface 40 (that is, the closed position) and a position where the closure seal 36 is moved from the valve seat surface 40 allowing pressurized gas to pass between the closure seal 36 and the valve seat surface 40 allowing the pressurized gas to pass from the intake port 28 through the gas lumen 38 and into the rotor assembly 24.

Controlled movement of the closure seal 36 is achieved by the provision of a lever operated cable 46 which may be acted upon by a lever 74 positioned on the handle 76 of the dirt bike 52 to selectively pull upon the support rod 44 moving the closure seal 36 from its closed position to its open position. The support rod 44, and ultimately the closure seal 36, is biased into its closed position by a spring 48 interposed within the gas lumen 38, and between the inner wall 42 of the gas lumen 38 and the support rod 44, for biasing the closure seal 36 to its closed position.

With the closure seal 36 in its open position, and the control valve 34 open, pressurized gas is permitted to flow into the rotor assembly 24 causing rotation of the rotor assembly 24 which ultimately causes rotation of the drive gear 26 which in turn rotates the drive shaft 20.

The rotor assembly 24 includes an internal housing 54 in which a rotor 56 is mounted upon bearings 104, 106 and positioned for rotation therein. In accordance with a preferred embodiment, the rotor 56 includes a plurality of resiliently biased vanes 58 which are acted upon by the pressurized gas or air source in a manner causing rotation thereof.

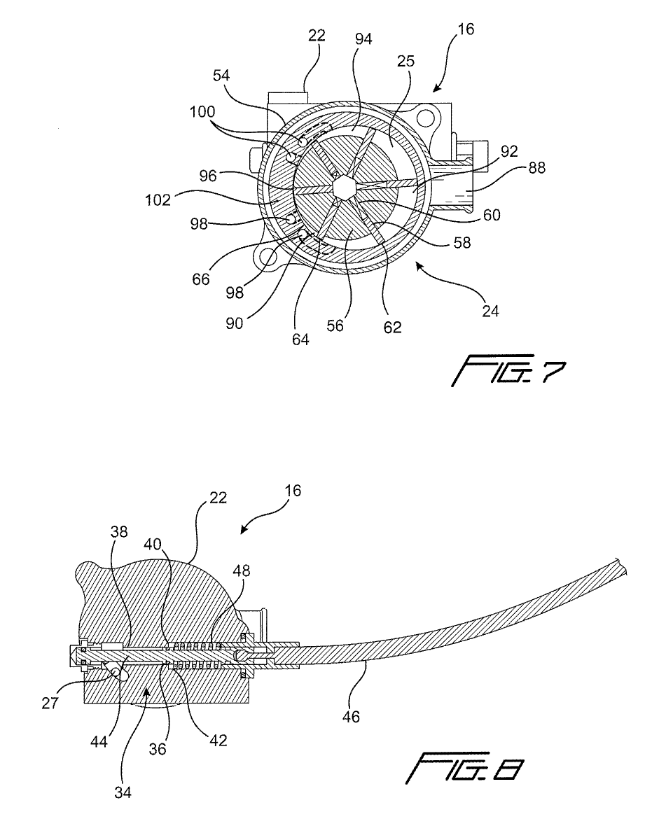

More particularly, the rotor assembly 24 includes a rotary member or rotor 56 having a plurality of slots 60 spaced around its periphery and an outwardly biased movable vane 58 positioned in each slot 60. The free ends 62 of the respective vanes 58 engage the inner or cam surface 64 of a cam ring 66 which surrounds the rotor 56. The free ends 62 of the respective vanes 58 are maintained in sliding, sealing engagement with the cam surface 64 of the cam ring 66 such that upon the application of pressure the vanes 58, and rotor 56, are rotated in a direction of lower pressure (for example, and as shown by the arrow in FIG. 7, in a counter-clockwise direction) from the intake port 27 to the exhaust port 88.

The cam surface 64 of the cam ring 66 is contoured so the distance between it and the periphery of the rotor 56 varies around the circumference of the rotor 56. A gas pumping or intervane space is defined by the rotor 56 periphery, the inner or cam surface 64 of the cam ring 66 and adjacent pairs of vanes 58. As the vanes 58 traverse the cam surface 64 they sequentially pass through an intake or suction zone 90, a transfer zone 92, an exhaust zone 94 and a sealing zone 96. As such, the housing 22 is provided with an exhaust port 88 for passage of used air out of the rotor assembly 24.

In the suction zone 90, inlet ports 98 in fluid communication with the intake port 27 in the cheek plates 102 open into the intervane space (that is, the cavity 25 of the rotor 24) and the cam surface 64 recedes from the rotor 56 to provide an enlarged pumping space. In the transfer zone 92, the distance between the cam surface 64 and the rotor 56 remains substantially constant. In the exhaust zone 94, the cam surface 64 approaches the rotor 56 to reduce the volume of the intervane space and exhaust the gas through outlet ports 100 in the cheek plates 102. Spacing between the cam surface 64 and the rotor 56 remains substantially constant in the sealing zone.

Since the distance between the cam surface 64 and the rotor 56 varies around the periphery of the cam surface 64, each vane 58 must be free to move in and out of its respective slot 60 in the rotor 56 as rotation progresses. Conventionally, vanes 58 and rotor slots 60 are carefully machined to have parallel faces to ensure smooth sliding of the vane 58 in the slot 60 with minimum gas leakage. It is important to the efficient operation of the rotor assembly 24 that each vane 58 remains in positive contact with the cam surface 64 but exerts a relatively low force on the cam surface 64 as the vane 58 traverses it. The present starter 16 utilizes one or more auxiliary mechanisms known to those skilled in the art for biasing the vanes 58 outwardly of their respective rotor slots 60, for example, and in accordance with a preferred embodiment of the present invention, springs are positioned within the recesses, and between the rotor and vane, to bias the vanes outwardly to engage the inner surface of the cam ring.

As discussed above, rotation of the rotor 56 causes rotation of the drive gear 26. In accordance with a preferred embodiment, the drive gear 26 is shaped and dimensioned for attachment to the drive shaft 20 via a series of intermediary gear members.

While the preferred embodiments have been shown and described, it will be understood that there is no intent to limit the invention by such disclosure, but rather, is intended to cover all modifications and alternate constructions falling within the spirit and scope of the invention.

1. A pneumatic starter system for a combustion engine of a recreational vehicle including one or more pistons moving within a respective plurality of cylinders, comprising:
a pneumatic pressure source;
a starter converting the pneumatic pressure source into rotational force applied to the one or more pistons causing movement of the one or more pistons and ignition of the combustion engine.

2. The pneumatic starter system according claim 1, wherein the starter includes a rotor assembly.

3. The pneumatic starter system according claim 1, wherein the combustion engine is a four-stroke combustion engine.

4. The pneumatic starter system according claim 1, wherein the starter is coupled to a drive shaft of the combustion engine to initiate combustion sufficient to fire the combustion engine.

5. The pneumatic starter system according claim 4, wherein the starter includes a starter housing in which a rotor assembly is linked to the pneumatic pressure source for rotation of a drive gear.

6. The pneumatic starter system according claim 5, wherein the drive gear is connected to the drive shaft of the combustion engine for rotation thereof.

7. The pneumatic starter system according claim 5, wherein the starter housing includes an intake port for selective connection of the pneumatic pressure source thereto via a connection tube.

8. The pneumatic starter system according claim 7, further including a cable actuated control valve forming part of the starter which selectively allows air or gas pressure from the pneumatic pressure source to supply energy to the starter.

9. The pneumatic starter system according claim 8, wherein the cable is connected to an actuator lever.

10. The pneumatic starter system according claim 8, wherein the control valve is positioned between the intake port and the rotor assembly.

11. The pneumatic starter system according claim 10, wherein the control valve includes a closure seal positioned for movement within a gas lumen formed in the starter housing for connecting the intake port to the rotor assembly.

12. The pneumatic starter system according claim 11, wherein the closure seal is mounted for movement between a closed position where the closure seal seats upon a valve seat surface formed on an inner wall of the gas lumen and an open position where the closure seal is moved from the valve seat surface and pressurized gas is allowed to freely pass from the intake port to the rotor assembly.

13. The pneumatic starter system according claim 5, wherein the rotor assembly includes an internal housing in which a rotor is positioned for rotation therein.

14. The pneumatic starter system according claim 13, wherein the rotor includes a plurality of resiliently biased vanes which are acted upon by pressurized gas or air from the pneumatic pressure source in a manner causing rotation thereof.

15. The pneumatic starter system according claim 1, wherein the pneumatic pressure source is mounted to an engine block of the recreational vehicle directly adjacent the combustion engine.

16. The pneumatic starter system according claim 1, wherein the pneumatic pressure source is formed in a swing arm of the recreational vehicle.

17. The pneumatic starter system according claim 1, wherein the pneumatic pressure source is a pressurized air cylinder.

18. The pneumatic starter system according claim 1, wherein the starter and the pneumatic pressure source are mounted to or in a frame of the recreational vehicle adjacent the combustion engine.

19. The pneumatic starter system according claim 1, wherein the pneumatic pressure source is constructed as part of a frame, engine block or swing arm of a conventional dirt bike.
